(19) United States
(12) Patent Application Publication
(10) Pub. No.: US 2013/0337802 A1
(43) Pub. Date: Dec. 19, 2013

(54) Managing Phone Numbers Associated With Multi-Mode Communication Devices

(71) Applicant: Bandwidth.com, Inc., Raleigh, NC (US)

(72) Inventors: David Morken, Chapel Hill, NC (US); Jared Kashimba, Micanopy, FL (US); Timothy Jones, Cary, NC (US); L. Anders Brownworth, Cambridge, MA (US)

(73) Assignee: Bandwidth.com, Inc., Raleigh, NC (US)

(21) Appl. No.: 13/967,765

(22) Filed: Aug. 15, 2013

Related U.S. Application Data
(63) Continuation of application No. 13/658,689, filed on Oct. 23, 2012.

(51) Int. Cl. H04W 76/02

(52) U.S. Cl. CPC H04W 76/02
USPC 455/426.1

(57) ABSTRACT

A contact server receives a request to initiate an out-bound call to a recipient device. The request identifies the caller device by a cellular network phone number. The contact server establishes a communication link with the caller device and determines its associated data network phone number. The contact server establishes a link with the recipient device, indicating that the data network phone number is the source of call, and bridges the two links. The contact server may also receive a request for an in-bound call to a recipient device. The request identifies the recipient device by its data network phone number. The contact server establishes a link with the caller device and determines a cellular network phone number associated with the recipient device. The contact server establishes a link with the recipient device using its cellular network phone number and bridges the two links.

### RELATED APPLICATIONS

This application claims priority to U.S. patent application Ser. No. 13/658,689 entitled “Systems And Methods For Managing Phone Numbers Associated With Multi-Mode Communication Devices”, which was filed on Oct. 23, 2012 and is incorporated herein by reference in its entirety.

### BACKGROUND

Multi-mode communication devices may be equipped with cellular transceivers to enable communication via a cellular network and may also be equipped with other hardware and/or software components for enabling communication via other types of networks, including data networks. Communication devices capable of communicating via multiple types of networks may be provided with functionality for handing-off a communication session from one type of network to another type of network. Typically, such a communication device will have a phone number assigned to it by the cellular network service provider and another phone number assigned to it by a data network service provider.

Management of multiple telephone numbers assigned to a single device can be cumbersome for both the user of the device and those trying to contact the user. For example, the user of the device will need to make others aware of both phone numbers if the user desires to be contacted via either the cellular network or the data network depending on connectivity. Those trying to contact the user may not know whether the user is connected to the cellular network or the data network and, thus, which phone number to use. Similarly, the communication device will need to be configured with software for switching between phone numbers when a call in progress is handed-off between the cellular network and the data network, so that the new network will recognize the communication device as belonging to a subscriber. What is needed, therefore, is a more efficient way to manage phone numbers associated with multi-mode communication devices.

### SUMMARY OF THE INVENTION

The present invention meets the above described needs by providing systems and methods, embodied in contact servers, communication devices and/or software program code, for managing phone numbers used establishing communication sessions between one or more multi-mode communication devices. Generally speaking, calls from a caller device to a recipient device are directed or redirected to a contact server. The contact server thus receives a request from a caller device to initiate a communication session with a recipient device. The initiation request identifies the caller device by a caller device phone number and identifies the recipient device by a recipient device phone number. In response to the initiation request, the contact server establishes a first communication link with the caller device. The contact server then determines, by way of the caller device phone number, whether the caller device belongs to a subscriber.

If the caller device belongs to a subscriber, the caller device phone number is assumed to be a cellular network phone number and the contact server determines a second caller device phone number (e.g., a data network phone number) associated with the caller device. The contact server transmits to the recipient device a request to participate in the communication session. The participation request indicates that the second caller device phone number (e.g., the data network phone number) is the source of the participation request.

If the contact server determines that the caller device does not belong to a subscriber, the recipient device number is presumed to be a data network phone number and the contact server determines a second recipient device phone number (e.g., a cellular network phone number) associated with the recipient device. In that case, the participation request is directed to the second recipient phone number and indicates that the caller device phone number is the source of the participation request.

After establishing a second communication link with the recipient device, the contact server bridges the first communication link and the second communication link to establish the communication session. These and other aspects, features and embodiments of the present invention will become apparent to one of skill in the art following a reading of the foregoing description of certain exemplary embodiments, in conjunction with the attached figures.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 depicts an exemplary networked environment for implementing certain exemplary embodiments of the present invention.

FIG. 2 is a flowchart illustrating operation of a communication device according to certain exemplary embodiments.

FIG. 3 is a flowchart illustrating operation of a contact server according to certain exemplary embodiments.

FIG. 4 is a flowchart illustrating further operation of the contact server according to certain exemplary embodiments.

FIG. 5 is a schematic block diagram illustrating typical components of a computing device that may be used for implementing a contact server and/or a communication device according to certain exemplary embodiments of the present invention.

### DETAILED DESCRIPTION

The present invention provides systems and methods for managing phone numbers associated with multi-mode communication devices. The systems and methods of the invention may be embodied in and performed by communication devices, servers and software instructions executed by such devices, as will be explained in detail below. A multi-mode communication device may be equipped with hardware and software for communication over at least two different types of networks, such as a cellular network and a data network. For example, a multi-mode communication device may include one or more cellular radio transceiver(s) and associated software for communicating over one or more cellular network (e.g., GSM, UMTS, CDMA, LTE, etc.), as well as one or more transceiver(s) and associated software for communicating over one or more a data network (e.g. IEEE 802.11 (Wi-Fi), IEEE 802.16 (WiMax), Digital Enhanced Cordless Telecommunications (DECT), High Speed Packet Access (HSPA), etc.). These and other types of multi-mode communication devices will occur to one of ordinary skill in the art.

Given the convergence of and interoperation among different types of network technologies, which blurs the line between various distinct networks, this disclosure focuses on access networks. An access network is the portion of a communications network that connects subscriber devices to a service provider's core network. Therefore, references herein to a communication device capable of connecting to or communicating via a cellular network refers to a communication device equipped with a cellular transceiver for communication with base stations and other cellular network access points. Similarly, references herein to a communication device capable of connecting to or communicating via a data network refers to a communication device equipped with a transceiver or other network interface for communication with a router or other data network access point.

In a data network, a contact server may be employed to manage communication sessions between multiple communication devices. For example, when a first communication device (e.g., a caller device) connected to the data network is operated to establish a communication session with a second communication device (e.g., a recipient device), a first communication link may be established between the caller device and the contact sever and a second communication link may be established between the contact server and the recipient device. The contact server may then bridge the two communication links to establish the communication session. The recipient device may or may not be connected to the data network. The contact server may interface with one or more cellular networks through gateway devices and other devices know in the art.

A multi-mode communication device will typically have at least two associated phone numbers. For example, a first phone number may be assigned to the communication device by a cellular network service provider. This first phone number, referred to herein as “cellular network phone number,” is used to identify the communication device as calls and other communications (e.g., short messages, etc.) are made to and from it over the cellular network. A second phone number may be assigned to the communication device by a data network provider, such as a voice-over-internet protocol (VoIP) provider. This second phone number, referred to herein as “data network phone number” is used to identify the communication device as calls and other communications are made to and from it over the data network.

In certain embodiments, the cellular network phone number and the data network phone number assigned to a communication device are managed in such a way that, from the user's perspective, the data network phone number can be used as the sole phone number for sending/receiving calls to/from the communication device, whether over the data network or a cellular network. For example, the interfaces and application of the communication device can be configured such that the user sees only the data network phone number as being associated with the phone and the cellular network phone number is hidden from view. At the network level, however, the cellular network phone number may remain the primary phone number used for establishing voice calls and other communications. A contact server may be placed in both the outbound and inbound call paths and may execute a service, referred to herein as a “phone number management service,” to ensure that outbound calls from the communication device appear to have originated from the data network phone number and that inbound calls directed to the data network phone number are properly routed to the communication device.

In other embodiments, the cellular network phone number and the data network phone number assigned to a communication device are managed in such a way that, from the user's perspective, the cellular network phone number can be used as the sole phone number for sending/receiving calls to/from the communication device, whether over the data network or cellular network. In these embodiments, the phone number management service ensures that outbound calls from the communication device appear to have originated from the cellular network phone number and that inbound calls directed to the cellular network phone number are properly routed to the communication device. Accordingly, although exemplary embodiments are described herein with respect to using a data network phone number as the “perceived” phone number for a communication device, while “hiding” the device's assigned cellular network phone number, the present invention is not limited as such. The principles of the present invention can be applied with respect to any communication device having multiple assigned device phone numbers, so that at least one such device phone number is used as the “perceived” phone number and the other device phone number(s) is/are “hidden,” from the users' perspective.

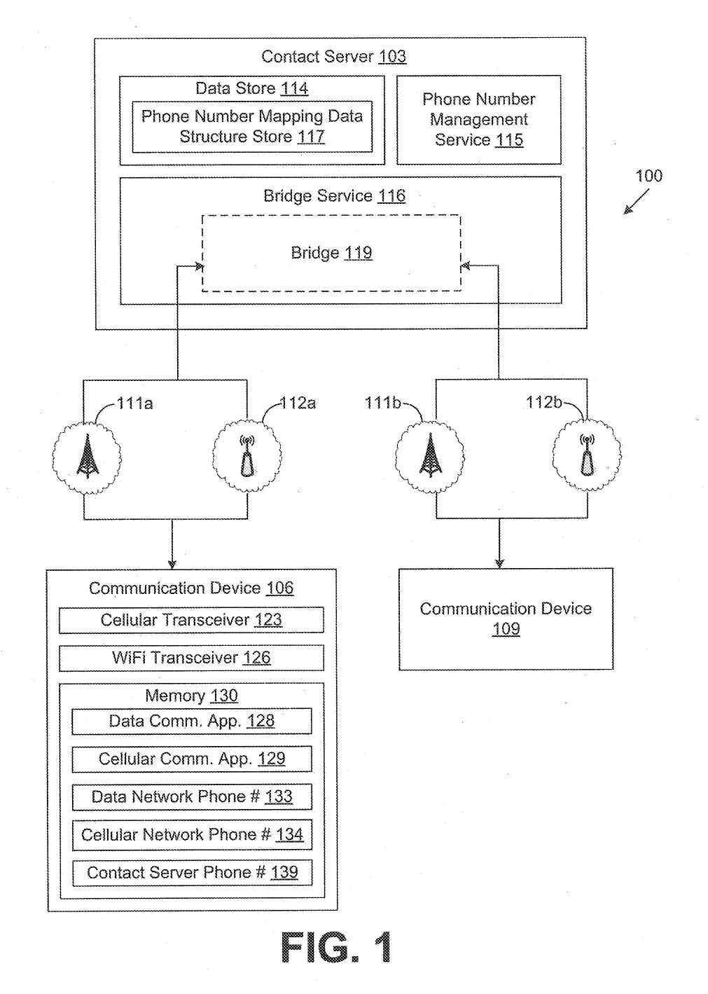

FIG. 1 shows an exemplary networked environment 100 for implementing certain exemplary embodiments of the present invention. The networked environment 100 includes a contact server 103, a plurality of communication devices 106 and 109, and a plurality of networks 111 and 112. One or more of the networks 111 and 112 can be used to interconnect the contact server 103 and the communication devices 106 and 109. The illustrated networks 111 and 112 include one or more cellular networks 111a and 111b and one or more data networks 112a and 112b.

In certain embodiments, cellular networks 111a and 111b include cellular networks or portions of cellular networks based on GSM, UMTS, CDMA, LTE and/or any other cellular network standards. The data networks 112a and 112b include, for example, the Internet, one or more intranets, wide area networks (WANs), local area networks (LANs), and the like, portions or all of which may be wireless and/or wired. For instance, a data network 112 may be a wireless network or a portion of a wireless network implemented using WiFi, WiMAX, DECT, HSPA and/or any other wireless data communication technology. As is known in the art, the resources the various networks 111 and 112 may interface with the contact server 103 through gateway devices, routers and/or other appropriate devices (not shown). Similarly, the communication devices 106 and 109 may interface with the various networks 111 and 112 through appropriate access points (not shown). Those skilled in the art will appreciate that the principles of the invention may be extended to any other type of network, including the public switched telephone network (PSTN), satellite communication networks, near field communication networks, etc.

The contact server 103 may comprise, for example, a server computer or any other system having computing capability. In addition, the contact server 103 comprises one or more software applications for providing with the functionality of the contact server. Alternatively, a plurality of contact servers 103 may be employed that are arranged, for example, in one or more server banks or computer banks or other arrangements. For example, a plurality of contact servers 103 together may comprise a cloud computing resource, a grid computing resource, and/or any other aggregated or distributed computing arrangement. Such contact servers 103 may be located in a single installation or may be distributed among many different geographical locations. For purposes of convenience, the contact server 103 is illustrated in FIG. 1 and referred to herein in the singular. Even though the contact server 103 is referred to in the singular, it is understood that a plurality of contact servers 103 may be employed in various arrangements as described above.

The contact server 103 may execute various applications and/or other functionality for, among other things, setting-up, managing and tearing-down communication sessions between communication devices 106 and 109. Also, various data is stored in a data store 114 that is part of or otherwise accessible to the contact server 103. The data store 114 illustrated in FIG. 1 may be representative of a plurality of data stores as can be appreciated. The data stored in the data store 114, for example, may be associated with the operation of the various applications and/or functional entities of the contact server as described below.

In certain embodiments, data store 114 may store one or more phone number mapping data structures 117 (e.g., databases, look-up tables, etc.). A phone number mapping data structure 117 maps a cellular network phone number assigned to a communication device with a data network phone number assigned to that device for each of a plurality of communication devices 106 and 109. As described, a cellular network phone number may be assigned to a communication device by a cellular network service provider. A cellular network phone number is typically provisioned in read-only memory (ROM) or a SIM card, of a communication device. Similarly, a data network phone number may be assigned to the communication device by a data network service provider.

The applications and/or functional entities of the contact server 103 may include, for example, a phone number management service 115, a bridge service 116, and other applications, services, processes, systems, engines, or functionality not discussed in detail herein. The phone number management service 115 is executed to ensure that outbound calls from the communication device (e.g., communication device 106) appear to have originated from the data network phone number assigned to the device and that inbound calls directed to that data network phone number are properly routed to the communication device. Operation of the phone number management service 115 will be discussed in more detail below.

The bridge service 116 is executed to create and manage bridges 119 for communication sessions between communication devices 106 and 109. By way of illustration, a bridge 119 may be used to join a communication link between a first communication device 106 and the contact server 103 with a communication link between the contact server and a second communication device 109. The bridge service 116 may monitor the bridge 119 to determine whether either or both of the communication devices 106 and 109 become disconnected. By uniquely identifying the bridge in association with the two communication devices 106 and 109, the bridge service 116 may be able to reconnect the first communication device 106 or the second communication device 109 to the bridge if that device loses its connection and attempts to re-connect through the same network or if a handoff occurs and the device attempts to re-connect through a different network.

The communication devices 106 and 109 illustrated in FIG. 1 are representative of a plurality of client devices that may be coupled to one or more of the networks 111 and 112. Each of the communications devices 106 and 109 may comprise, for example, a processor-based or other computing system. For example, one or more of the communications devices 106 and 109 may be embodied in the form of a desktop computer, a laptop computer, a personal digital assistant, a cellular telephone, a set-top box, a music player, a web pad, a tablet computer, a game console, or any other device with like capabilities, including hardware and software components for establishing communication sessions via at least one of the networks 111 and 112.

At least one of the communication devices 106 and 109 includes hardware and software components for establishing communication sessions via at least two of the different networks 111 and 112. For example, one or both of the communication devices 106 and 109 may comprise a cellular transceiver 123, and a Wi-Fi transceiver 126. The cellular transceiver 123 may be configured to receive and transmit data over a cellular network 111. The Wi-Fi transceiver 126 may be configured to receive and transmit data over a data network 112. Additionally, the devices 106 and 109 may include components (e.g., modem or network interface unit) configured to receive and transmit data over other types of networks, including without limitation the PSTN.

A communication device (e.g., communication device 106) includes memory 130 (e.g., RAM, ROM, SIM card, etc.) for storing data and software. Data stored in the memory 130 includes a data network phone number 133 and a cellular network phone number 134 assigned to the communication device. The data may also include a contact server phone number (or other network address identifier) assigned to the contact server 103. The software stored in the memory 130 includes one or more “data communication application” 128 enabling the communication device to participate in communication sessions over a data network 112 and one or more “cellular communication application” 129 enabling the communication device to participate in communication sessions over a cellular network 111. The software stored in the memory 130 may also include other applications such as, for example, email applications, instant message applications, and/or other communication applications.

In certain embodiments, the data communication application 128 or another application may be configured for determining whether a data network 112 is accessible by the communication device 106. If a data network 112 is accessible, the data communication application 128 may be given priority over the cellular communication application 129 such that communication sessions will take place over the data network 112 instead of the cellular network 111. For example, the communication device 106 may be within a range of an access point associated with a public data network 112. As another example, the communication device 106 may be within a range of an access point associated with a secured data network 112 and have credentials for accessing the secured data network 112. In one embodiment, a driver executable implemented on the communication device 106 may determine whether a data network 112 is accessible and assign priority to the data communication application 128 accordingly. Alternatively, the user of the communication device 106 may determine whether to access the data network 112 by invoking or otherwise interacting with the data communication application 128.

Conversely, if a data network 112 is not accessible, then the cellular communication application 129 may be given priority. In one embodiment, a driver executable implemented on the communication device 106 may determine that a data network 112 is not accessible and assign priority to the cellular communication application 129 accordingly. Alternatively, the communication device 106 may be configured such that the cellular communication application 129 is the default communication application and will be used for communication over the cellular network 111 unless the data communication application 126 is invoked or otherwise given priority. When the cellular communication application 129 is executed it may first determine whether there is an accessible cellular network 111 and, if so, communication sessions will take place over the cellular network 111.

The communication device 106 may be configured such that the cellular network phone number 134 is “hidden” from the user and the data network phone number 133 is perceived by user to be the only phone number associated with the communication device 106. Configuring the communication device 106 in this manner may involve modifications to the user interface of the communication device 106, its cellular communication application 129 and/or its other various applications so that only the data network phone number 133 is displayed to the user. The communication applications (e.g., cellular communication application 129 and data communication application 128) may also be configured to route all outbound calls from the communication device 106 through the contact server 103, which will connect the call to the intended party and ensure that the call appears to have originated from the data network phone number 134 of the communication device 106.

For example, when the user of the communication device (referred to in this example as the “caller device”) 106 dials a phone number associated with another communication device (referred to in this example as the “recipient device”) 109, the cellular communication application 129 or the data communication application 128, as applicable, may substitute the dialed phone number with the contact server phone number 139 or an Internet Protocol (IP) address or another network identifier associated with the contact server 103, so that a first communication link will be established between the caller device 106 and the contact server 103. The caller device 106 (i.e., by way of the cellular communication application 129 or the data communication application 128, as applicable) may be configured to send the actual dialed phone number to the contact server 103, which the contact server 103 will use to establish a second communication link between itself and the recipient device 109. In some embodiments, the caller device 106 will be identified to the contact server 103 by its cellular phone number 134. In other words, the signaling and messaging between the caller device 106 and the contact server 103 will identify the cellular phone number 134 of the caller device 106 as the “from” phone number.

Before establishing the second communication link with the recipient device 109, the contact server 103 (e.g., by way of the phone number management service 115) may be configured to consult the phone number mapping data structure 117 to determine the data network phone number 133 corresponding to the cellular network phone number 134 of the caller device 106. The contact server 103 will use this data network phone number 133 as the “from” phone number when establishing the second communication link, so that the recipient device 109 perceives that the communication originated from the data network phone number 133. Those skilled in the art will appreciate that the second communication link between the contact server 103 and the recipient device 109 may be established via either a data network 112b or a cellular network 111b, depending on the connectivity of the recipient device 109. Once the second communication link is established, the contact server 103 (e.g., by way of the bridge service 116) bridges the first and second communication links together (e.g., by way of bridge 119) to establish a communication session between the caller device 106 and the recipient device 109.

Inbound calls directed to the communication device 106 are handled by the contact server 103 in a similar manner. By way of example, the user of another communication device (referred to in this example as the “caller device”) 109 may dial the data network phone number 133 associated with the communication device (referred to in this example as the “recipient device”) 106. Using routing and switching techniques well known in the art, calls to the data network phone number 133 of the recipient device 106 may be directed or redirected to the contact server 103 rather than directly to the recipient device 106.

In this manner, a first communication link is established between the caller device 109 and the contact server 103. The contact server 103 (e.g., by way of the phone number management service 115) may be configured to consult the phone number mapping data structure 117 to determine the cellular network phone number 134 corresponding to the data network phone number 133 of the recipient device 106. The contact server 103 will use this cellular network phone number 134 as the “to” phone number when establishing a second communication link with the recipient device 106.

In some embodiments, the contact server 103 may be configured to determine whether the recipient device 106 is accessible over the data network 112 and, if so, to use the data network 112 for establishing the second communication link. For example, the contact server 103 or another device, such as a DNS server, may resolve the cellular network phone number 134 (or the data network phone number 133) of the recipient device 106 into a corresponding IP address or other network identifier associated with the recipient device 106 and thereby establish a communication link with the recipient device 106. If the recipient device 106 is not accessible over the data network 112, the contact server 103 may be configured to establish the second communication via the cellular network 111 using the cellular network phone number 134. Once the second communication link is established, the contact server 103 (e.g., by way of the bridge service 116) bridges the first and second communication links together (e.g., by way of bridge 119) to establish a communication session between the caller device 109 and the recipient device 106.

As mentioned, multiple contact servers may be deployed in an aggregated and/or distributed fashion, for example in a centralized location (server farm, data center, etc.) or in multiple geographic locations. Routing and switching techniques may thus be used to direct calls to particular data network phone numbers to one or more selected contact servers for purposes of load balancing, least cost routing or to achieve other efficiencies. For instance, one or more contact servers may be dedicated or used primarily for handling calls placed to data network phone numbers having a particular set or range of area codes. As an example, one or more contact servers may be located in or otherwise assigned to a particular state or region for handling calls placed to data network phone numbers having area codes assigned to that state or region. Other call distribution schemes will occur to those of ordinary skill in the art and are deemed to be within the scope of the present invention.

In some embodiments, it may be necessary in certain cases to “expose” the otherwise “hidden” cellular network phone number 134 of a communication device 106, such that a recipient perceives a call as originating from the cellular network phone number 134 and not the data network phone number 133. For example, emergency services calls such as 9-1-1 calls may be automatically routed to a Public Safety Answering Point (PSAP), which use specialized software for determining a caller's geographic location based on the phone number used to originate the call. Replacing the cellular network phone number 134 with the data network phone number 133 as the “from” phone number for such a call would result in the 9-1-1 operator being unable to determine the caller's location. Therefore, the data communication application 128 and/or the cellular communication application 129 of the communication device 106 may be configured to override the functionality described above.

For example, if it is detected that user has dialed 9-1-1 or another emergency services number, the data communication application 128 and/or the cellular communication application 129 may be configured to determine whether the mobile device 106 is connected to or otherwise within range of the cellular network 111. If so, the cellular communication application 129 may be configured to place the call directly to the emergency services system over the cellular network, i.e., without redirecting the call to the contact server 103. If the cellular network 111 is not accessible to the communication device 106, the data communication application 128 may be invoked and may redirect the call to the contact server 103 as described, but may instruct the contact server 103 to use the cellular network phone number 134 of the communication device 106 as the “from” phone number when establishing a communication link with the emergency services system. Alternatively, the phone number management service 115 of the contact server may be configured to detect an emergency services call and to bypass the process of replacing the cellular network phone number 134 of the communication device 106 with its data network phone number 133 before establishing the communication link with the emergency services system.

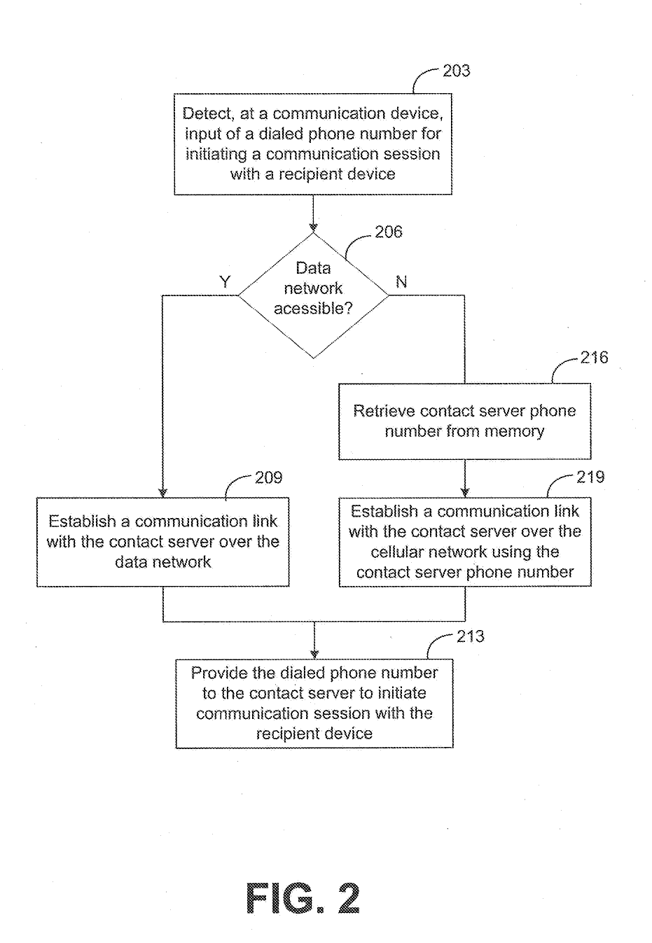

FIG. 2 is a flowchart illustrating operation of a communication device 106 (FIG. 1) according to certain exemplary embodiments. It is understood that the flowchart of FIG. 2 provides merely an example of the many different types of functional arrangements that may be employed to implement certain operations of the communication device 106 as described herein. As an alternative, the flowchart of FIG. 2 may be viewed as depicting an example of steps of a method implemented in the networked environment 100 (FIG. 1) according to one or more embodiments.

Beginning with step 203, the communication device 106 (FIG. 1) detects input of a dialed phone number for initiating a communication session with a recipient device. For example, a user operating the communication device 106 may dial a phone number associated with the recipient device on a user interface of the communication device 106. The user interface of the communication device 106 may be a touch screen, a number pad, a keyboard, and/or other types of interfaces.

In step 206, the communication device 106 determines whether a data network 112a is accessible. For example, the communication device 106 may scan for any accessible data networks 112a via the Wi-Fi transceiver 126, as previously discussed. The communication device 106 may then establish a connection with the accessible data network 112a. In another embodiment, the communication device 106 may already be connected to the accessible data network 112a. If the communication device 106 determines that a data network 112a is accessible, then the communication device 106 advances to step 209.

In step 209, the communication device 106 establishes a communication link with a contact server 103 over the data network 112a. For example, the communication device 106 may direct communications to the contact server 103 over the data network using a contact server phone number 139, an IP address, a URL or any other appropriate network identifier associated with the contact server 103. Then, in step 213, the communication device 106 provides the dialed phone number to the contact server 103 to initiate the communication session with the recipient device. For example, the communication device 106 may send the dialed phone number to the contact server by way of DTMF pulses, which may be packetized for transmission over the data network 112a. The communication device 106 may be configured to send the dialed phone number to the contact server 103 using a background process or otherwise in a manner such that the user of the communication device 106 is not aware of the transmission. For instance, the communication device 106 may mute its sound output while transmitting the dialed phone number using DTMF pulses. When the contact server 103 receives the dialed phone number it may then establish a bridge 119 for the communication session between the communication device 106 and the recipient device.

Returning to step 206, if the communication device 106 determines that a data network 112a is not accessible, then the communication device 106 advances to step 216. In step 216, the communication device 106 retrieves a contact server phone number 139 stored in the memory 130. Then in step 219, the communication device 106 establishes a communication link with the contact server 103 over the cellular network 111a using the contact server phone number 139. For example, the communication device 106 may dial the contact server phone number 139. In step 213, the communication device provides the dialed phone number to the contact server 103 to initiate the communication session with the recipient device.

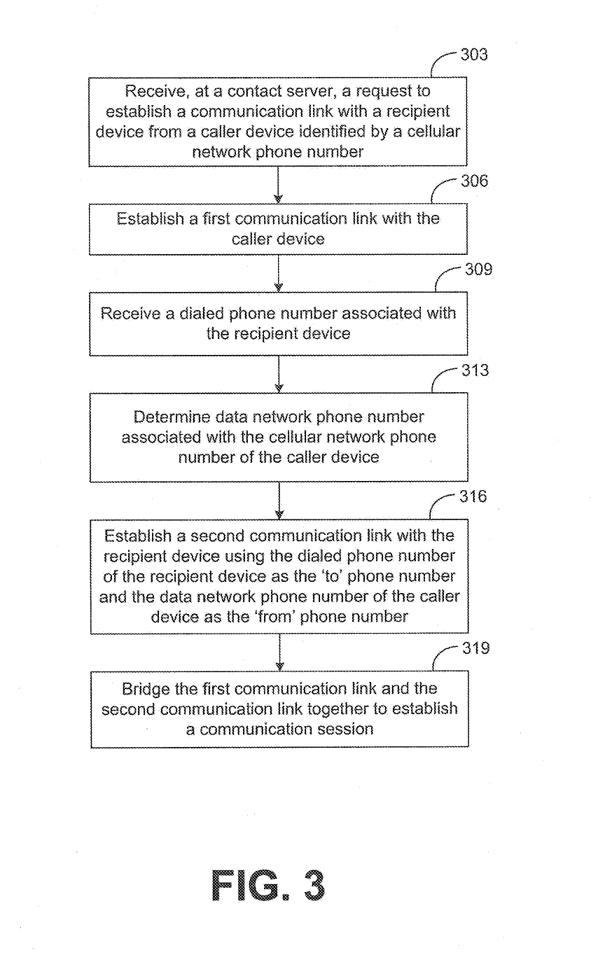

FIG. 3 is a flowchart illustrating operation of a contact server 103 (FIG. 1) according to certain exemplary embodiments. The example of FIG. 3 describes call flow processing for the scenario in which an outbound call is placed by a subscriber of a data service provider (e.g., using a multi-mode communication device configured for communications via a data network and a cellular network) to a recipient device which may or may not be operated by another subscriber of the data service provider. It is understood that the flowchart of FIG. 3 provides merely an example of the many different types of functional arrangements that may be employed to implement certain operations of the contact server 103 as described herein. As an alternative, the flowchart of FIG. 3 may be viewed as depicting an example of steps of a method implemented in the networked environment 100 (FIG. 1) according to one or more embodiments.

Beginning with step 303, the contact server 103 receives a request to establish a communication session. The request is received from the caller device 106 over a cellular network 111a or a data network 112a. The caller device 106 is identified by a cellular network phone number 134. For example, the cellular network phone number 134 may have been previously provided by a cellular network service provider. In step 306, the contact server 103 establishes a first communication link with the caller device 106, i.e., over either the cellular network 111a or the data network 112a, as applicable. The contact server 103 may be configured to recognize or determine, e.g., by way of the phone numbers or other identifiers assigned to the caller device 106 and the recipient device, respectively, whether the caller device 106 belongs to a subscriber of the data service provider and whether the recipient device 109 belongs to a subscriber of the data service provider. If the caller device belongs to a subscriber, which is assumed in the example of FIG. 3, the call processing continues to step 309.

In step 309, the contact server 103 receives from the caller device 106 a dialed phone number associated with the recipient device 109. For example, the request received from the caller device 106 may include the dialed phone number, or the dialed phone number may subsequently transmitted by the caller device 106. In step 313, the contact server 103 then determines the data network phone number 133 of the caller device 106. For instance, the contact server 103 accesses the phone number mapping data structure 117 in the data store 114 of the contact server 103 to identify the data network phone number 133 of the caller device 106. The phone number mapping data structure 117 may include a lookup table, data base or other data structure mapping cellular network phone numbers 134 to corresponding data network phone numbers 133 of subscriber communication devices.

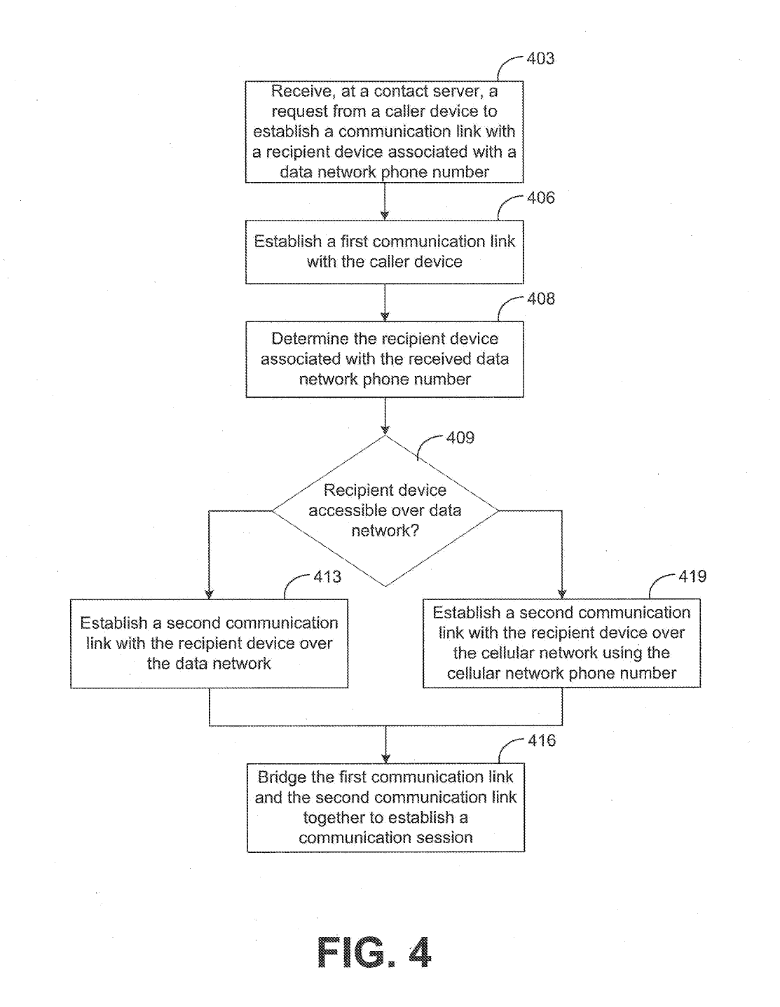

Having determined the data network phone number 133 of the caller device 106, the contact server 103 advances to step 316. In step 316, the contact server 103 establishes a second communication link with the recipient device 109, which, again may or may not be operated by a subscriber of the data service provider. (See FIG. 4 for more specific details regarding inbound call processing for calls placed to a subscriber recipient device). In particular, the contact server 103 transmits to the recipient device 109 a request to participate in the communication session (i.e., places a call to the recipient device 109). The participation request indicates that the data network phone number 133 of the caller device 106 is the source of the request. In other words, the contact server 103 uses the dialed phone number associated with the recipient device 109 as the “to” phone number for establishing the second communication link and uses the data network phone number 133 associated with the caller device 106 as the “from” phone number. Accordingly, the user operating the recipient device 109 receives a notification that a user associated with the data network phone number 133 wishes to engage in a communication session. The user operating the recipient device 109 is unaware of the cellular network phone number 134 associated with the caller device 106.

Then, in step 319, the contact server 103 bridges the first communication link and the second communication link together to establish the communication session. For example, the bridge service 116 may manage the bridge 119 for the communication session, as previously described.

FIG. 4 is a flowchart illustrating operation of the contact server 103 (FIG. 1) according to certain exemplary embodiments. The example of FIG. 4 describes call flow processing for the scenario in which an inbound call is placed from a communication device that may or may not be operated by a subscriber of a data service provider to a recipient device that is operated by a subscriber of the data service provider. It is to be understood that the flowchart of FIG. 4 provides merely an example of the many different types of functional arrangements that may be employed to implement certain operations of the contact server 103 as described herein. As an alternative, the flowchart of FIG. 4 may be viewed as depicting an example of steps of a method implemented in the networked environment 100 (FIG. 1) according to one or more embodiments.

Beginning with step 403, the contact server 103 receives a request from a caller device 109 to establish a communication session. The caller device 109 directed the request to a data network phone number 133 used to identify a recipient device 106. However, the communications to that data network phone number 133 were automatically routed or rerouted to the contact server 103. In step 406, the contact server 103 establishes a first communication link with the caller device 109. For instance, the contact server 103 establishes the first communication link with the caller device 109 over a cellular network 111 or a data network 112. The contact server 103 may be configured to recognize or determine, e.g., by way of the phone numbers or other identifiers assigned to the caller device 109 and the recipient device 106, respectively, whether the caller device 109 belongs to a subscriber of the data service provider and whether the recipient device 106 belongs to a subscriber of the data service provider. If the recipient device 106 belongs to a subscriber, which is assumed in the example of FIG. 4, the call processing continues to step 408.

In step 408, the contact server 103 determines the recipient device 106 associated with the received data network phone number 133. The contact server 103 may do so by identifying a cellular network phone number 134, IP address or other network identifier associated with the data network phone number 133. In one embodiment, the contact server 103 identifies the recipient device 106 by consulting the phone number mapping data structure 117 stored in the data store 114 of the contact server 103.

In step 409, the contact server 103 may determine whether the recipient device 106 is accessible over the data network 112a. In one embodiment, the contact server 103 may ping a known IP address associated with the recipient device 106 or may interact with other network devices to determine whether the recipient device 106 is accessible over the network 112a. If the contact server 103 determines that the recipient device 106 is accessible over the data network 112a, then the contact server advances to step 413. In step 413, the contact server 103 establishes a second communication link with the recipient device 106 over the data network 112a. For example, the contact server 103 may transmit to the recipient device 106 a request to participate in the communication session using the known IP address or may direct the participation request to the cellular network phone number associated with the recipient device 109 using VoIP and/or other data network protocols. The participation request indicates that the phone number of the caller device 109 is the source of the request. The phone number of the caller device will be a data network phone number 133 in the case where the caller device 109 belongs to a subscriber of the data service provider and will be a cellular network phone number in the case where the caller device 109 does not belong to a subscriber. Then, in step 416, the contact server 103 bridges the first communication link and the second communication link together to establish a communication session. For example, the bridge service 116 may manage the bridge 119 for the communication session, as previously described.

Returning to step 409, if the contact server 103 determines that the recipient device is not accessible over the data network 112a, then the contact server 103 advances to step 419. In step 419, the contact server 103 establishes a second communication link with the recipient device 106 over the cellular network 111a using the cellular network phone number 134 of the recipient device 106. For example, the contact server 103 may communicate with the recipient device 106 over the cellular network 111a managed by a cellular network service provider using the cellular network phone number 134 of the recipient device 106. Again, the participation request indicates that the phone number of the caller device 109 is the source of the request. Then, in step 416, the contact server 103 bridges the first communication link and the second communication link together to establish a communication session. For example, the bridge service 116 may manage the bridge 119 for the communication session, as previously described.

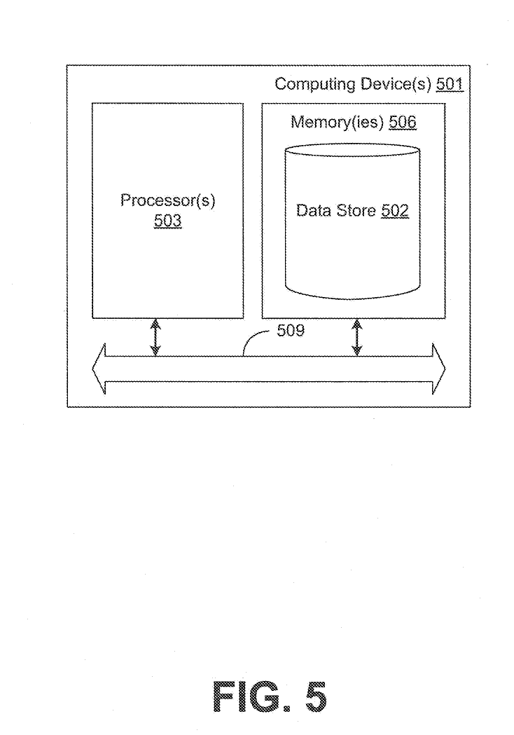

With reference to FIG. 5, shown is a schematic block diagram of a computing device 501 such as a contact server 103 and a communication device 106, according to an embodiment of the present disclosure. The computing device 501 includes at least one processor circuit, for example, having a processor 503 and a memory 506, both of which are coupled to a local interface 509. To this end, the computing device 501 may comprise, for example, at least one server computer, at least one communication device, or like device. The local interface 509 may comprise, for example, a data bus with an accompanying address/control bus or other bus structure as can be appreciated.

Stored in the memory 506 are both data and several components that are executable by the processor 503. In particular, where the computing device 501 is configured as a contact server 103, the phone number management service 115 and bridge service 116 may be stored in the memory 506 and executable by the processor 503, to perform the functions previously described. Additionally, where the computing device 501 is configured as a computing device 106, the data communication application 128 and the cellular communication application 129 of the communication device 106 may be stored in the memory 506 and executable by the processor 503, to perform the functions previously described. Also stored in the memory 506 may be a data store 502 and other data. For example, the data store 502 may correspond to the data store 114 of the contact server 103. In addition, an operating system may be stored in the memory 506 and executable by the processor 503.

It is understood that there may be other applications that are stored in the memory 506 and are executable by the processors 503 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and the memory 506 may represent multiple memories 506 that operate in parallel processing circuits, respectively. In such a case, the local interface 509 may be an appropriate network 111 and 112 (FIG. 1) that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the phone number management service 115, the bridge service 116, the data communication application 128, the cellular communication application 129, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 2-4 show the functionality and operation of an implementation of portions of the communication device 106 and contact server 103 115, respectively. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 2-4 show a specific order of execution, it is understood that the order of execution may differ from that which is depicted. For example, the order of execution of two or more lines may be scrambled relative to the order shown. Also, two or more lines and/or steps shown in succession in FIGS. 2-4 may be executed concurrently or with partial concurrence. Further, in some embodiments, one or more of the lines and/or steps shown in FIGS. 2-4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method for establishing a communication session, comprising:
at a contact server hosted within an Internet Protocol (IP) network:
receiving an initiation request from a caller device to initiate a communication session with a recipient device, the initiation request identifying the caller device by a first telephone number associated with a mobile cellular network and the recipient device by a recipient device identifier;
establishing a first communication link with the caller device over the mobile cellular network upon receipt of the initiation request;
retrieving a second telephone number for the caller device, the second telephone number associated with a data network;
transmitting a participation request to the recipient device via the recipient device identifier to establish a communication session with the caller device, the participation request indicating that the second telephone number for the caller device associated with data network is the source of the participation request;
establishing a second communication link with the recipient device upon receipt of an acknowledgment of the participation request; and
joining the first communication link with the second communication link to establish the communication session.

2. The method of claim 1, the step of retrieving a second telephone number for the caller device comprising:
accessing a database having mobile cellular network telephone numbers that correspond with data network telephone numbers;
looking up the mobile cellular network telephone number received in the initiation request; and
retrieving a corresponding data network telephone number associated with the mobile cellular network telephone number.

3. The method of claim 1, wherein the recipient device identifier is a telephone number.

4. The method of claim 3, wherein the second communication link spans one or more of a mobile cellular network, a packet based Voice-over IP (VoIP) network, and a public switched telephone network (PSTN).

5. A method for establishing a communication session, comprising:
at a contact server hosted within an Internet Protocol (IP) network:
receiving an initiation request from a caller device to initiate a communication session with a recipient device, the initiation request identifying the caller device by a caller device identifier and the recipient device by a first telephone number associated with a data network;
establishing a first communication link with the caller device upon receipt of the initiation request;
retrieving a second telephone number for the recipient device, the second telephone number associated with a mobile cellular network;
transmitting a participation request to the recipient device over the mobile cellular network via the second telephone number to establish a communication session with the caller device;
establishing a second communication link with the recipient device over the mobile cellular network upon receipt of an acknowledgment of the participation request; and
joining the first communication link with the second communication link to establish the communication session.

6. The method of claim 5, the step of retrieving a second telephone number for the recipient device comprising:
accessing a database having mobile cellular network telephone numbers that correspond with data network telephone numbers;
looking up the data network telephone number received in the initiation request; and
retrieving a corresponding mobile cellular network telephone number associated with the data network telephone number.

7. The method of claim 5, wherein the caller device identifier is a telephone number.

8. The method of claim 7, wherein the first communication link spans one or more of a mobile cellular network, a packet based Voice-over IP (VoIP) network, and a public switched telephone network (PSTN).

9. A system comprising:
a contact server in an Internet Protocol (IP) based packet data network operative to:
receive an initiation request from a caller device to initiate a communication session with a recipient device, the initiation request identifying the caller device by a first telephone number associated with a mobile cellular network and the recipient device by a recipient device identifier;
establish a first communication link with the caller device over the mobile cellular network upon receipt of the initiation request;
retrieve a second telephone number for the caller device, the second telephone number associated with a data network;
transmit a participation request to the recipient device via the recipient device identifier to establish a communication session with the caller device, the participation request indicating that the second telephone number for the caller device associated with data network is the source of the participation request;
establish a second communication link with the recipient device upon receipt of an acknowledgment of the participation request; and
join the first communication link with the second communication link to establish the communication session.

10. The system of claim 9, the contact server further operative to:
access a database having mobile cellular network telephone numbers that correspond with data network telephone numbers;
look up the mobile cellular network telephone number received in the initiation request; and
retrieve a corresponding data network telephone number associated with the mobile cellular network telephone number.

11. The system of claim 9, wherein the recipient device identifier is a telephone number.

12. The system of claim 11, wherein the second communication link spans one or more of a mobile cellular network, a packet based Voice-over IP (VoIP) network, and a public switched telephone network (PSTN).

13. A system comprising:
a contact server in an Internet Protocol (IP) based packet data network operative to:
receive an initiation request from a caller device to initiate a communication session with a recipient device, the initiation request identifying the caller device by a caller device identifier and the recipient device by a first telephone number associated with a data network;
establish a first communication link with the caller device upon receipt of the initiation request;
retrieve a second telephone number for the recipient device, the second telephone number associated with a mobile cellular network;
transmit a participation request to the recipient device over the mobile cellular network via the second telephone number to establish a communication session with the caller device;
establish a second communication link with the recipient device over the mobile cellular network upon receipt of an acknowledgment of the participation request; and
join the first communication link with the second communication link to establish the communication session.

14. The system of claim 13, the contact server further operative to:
access a database having mobile cellular network telephone numbers that correspond with data network telephone numbers;
look up the data network telephone number received in the initiation request; and
retrieve a corresponding mobile cellular network telephone number associated with the data network telephone number.

15. The system of claim 13, wherein the caller device identifier is a telephone number.

16. The system of claim 15, wherein the first communication link spans one or more of a mobile cellular network, a packet based Voice-over IP (VoIP) network, and a public switched telephone network (PSTN).
